(19) United States
(12) Patent Application Publication
(10) Pub. No.: US 2004/0062919 A1
(43) Pub. Date: Apr. 1, 2004

(54) Protective heat reflective film for the construction industry, especially used as an inner lining

(76) Inventors: Berndt Kuchenmeister, Delingsdorf (DE); Erwin Vahle, Warburg (DE)

Correspondence Address: Stephen M De Klerk, Blakely Sokoloff Taylor & Zafman, 12400 Wilshire Blvd Seventh Floor, Los Angeles, CA, 90025-1026, US

(21) Appl. No.: 10/362,957

(22) PCT Filed: Aug. 24, 2001
(86) PCT No.: PCT/EP01/09809

(30) Foreign Application Priority Data
Aug. 24, 2000 (DE) 100 41 526.1

(51) Int. Cl. B32B 7/02

(52) U.S. Cl. 428/215

(57) ABSTRACT

The invention relates to a heat reflective film for the construction industry, comprising a base film containing polyurethane, characterized in that the base film is damped on both sides with a metallization coating. The heat-reflective film can be diffusion open or diffusion closed.

The invention concerns a protective thermal reflective sheeting for the building industry, specifically as prestressed subroofing, and its manufacturing method.

A roof is meant to protect buildings and their inhabitants against a variety of environmental effects and impacts. In the past, roofs merely used to be protective shields against rain, snow, hail, wind and direct sunlight. Nowadays, however, roofs are expected to perform additional functions, such as regulating a comfortable room temperature and lowering the need for heating or cooling while optimizing energy costs.

Many countries are expected to pass laws in the future aiming at maximizing the energy savings potential of buildings. The two main reasons for low-energy houses are:

1. The European Commission has recognized that buildings are responsible for 40% of the total carbon dioxide emissions;

2. The majority of countries participating in the last World Climate Conference have committed to remain within certain predefined flue gas limits by the year 2010.

The future third ordinance on energy reduction will make modern low-energy construction mandatory in order to lower the current energy consumption by 25-30%.

Furthermore, many sections of the population have a need for protection against electromagnetic influences and stresses, which constantly increase in ever-growing fields of our daily lives because of the advent of electronics. This does not involve security installations, but concerns protection against “electrosmog” in single-family homes and apartment buildings.

Wood protection is another important field in roof construction. These days, it is desired to abstain from using chemical wood preservatives to protect against the weather not only for interior residential spaces, but also for exterior supporting parts, such as roofs.

Following DIN 68 800-2, the use of chemical wood preservatives for rafters (the load-bearing parts of the roof) can be abstained from if:

1. A complete insulation is used in which the entire free space between the rafters (“truss”) is completely filled with mineral fibrous insulating materials, or in which the partial insulation of the cavity in the truss is covered to avoid air from entering and provide protection against insects (house longhorn beetle infestation), and

2. Diffusion-permitting prestressed subroofing with a diffusion-resistance (diffusion equivalent air space thickness) s₄-0.2 m is used. This is meant to increase the evaporation capacity for the emission of unwanted increased humidity in such a way that fungus growth on the chemically unprotected wood is avoided, and furthermore if

3. The room-side of the roof is equipped with a windproof moisture retardant (diffusion-resisting sheeting).

Flat roofs, on the other side, require an insulating layer as well as a vapor barrier (diffusion-resisting prestressed subroofing) above the supporting building component profile in order to eliminate the use of a wood preservative.

There are some types of diffusion-permitting subroofing by the current state of the art. They consist, for example, of high-density polyethylene (HDPE), HDPE/polypropylene, non-woven polypropylene with a waterproof, diffusion-permitting polypropylene coat and non-woven polyester with a polyurethane coat. Diffusion-resisting sheeting used in roof construction is usually made of polyethylene or polyamide.

DE 28 55 484 A describes a diffusion-resisting sandwich sheeting, which can be used as a roof cover. Its interior layer could be composed of high-pressure polyethylene with an adhesive aluminum foil coating on one or both sides. Such coated foils have certain disadvantages when used in roof construction, since the sheeting is commonly nailed to the roof timbers. In case of coated sheeting, humidity could penetrate through these holes into the coating, thus leading to a decreased performance and accelerated aging of the sheeting. Furthermore, such sheeting is susceptible to fissuring and is non-resistant against deformation from heat radiation.

In particular, the heat reflection as well as the above-mentioned electromagnetic shielding of these types of state of the art prestressed subroofing can be improved, while improving good mechanical and aging characteristics. This was the purpose of the present invention.

This purpose is met by the thermal reflective sheeting described in claim 1, as well as its manufacturing method described in claim 22.

The thermal reflective sheeting in this invention is a modern high technology building material offering healthier living to the inhabitants of a building. Furthermore, it is an ecologically sound way to lower carbon dioxide emissions and optimize energy costs.

The thermal reflective sheeting in this invention is wind- and waterproof (resistant to rain and downpours), emission-free and extremely fissure-resistant. The thermal reflective sheeting is also highly UV-resistant and light-proof, resulting in an excellent longevity (a minimum life of 20 years). The heat reflection lies around 95% and it has a temperature resistance ranging from −45° C. to +95° C. Its electromagnetic properties include excellent shielding properties over a wide range of temperatures and frequencies.

The sub-claims list concretions and advantageous physical forms.

A protective coat is favorably applied directly on top of both metallized layers of the thermal reflective sheeting described in this invention. This secures the physical soundness and corrosion-resistance of the sheeting.

The thermal reflective sheeting described in this invention can be impervious to water vapors and air (diffusion-resisting). This design comes in the form of prestressed subroofing intended as a heat reflector and climate shield for air-conditioned buildings in subtropical and tropical countries with strong sunlight and a high degree of humidity. This is because non-reflected heat and warm water vapors with a high heating capacity penetrating the roof, heat the rooms underneath the roof. For this purpose, the sheeting can also be conveniently used for the construction of ceilings and walls.

In moderate climates, the diffusion-resisting thermal reflective sheeting can also be used on a flat roof on top of an insulation layer. As mentioned above, the reason for this is that a vapor barrier is necessary over the supporting building component profile when working without wood preservatives.

The diffusion-permitting design is a second variant of the thermal reflective sheeting described in the invention. In our parts of the world, this design is also used as prestressed subroofing for pitched roofs. According to the invention, the diffusion-permitting design is created by means of micro-perforation. This could be done, for example, with needle perforation. Micro-perforation with a laser beam is preferred, however. This allows for perforations with very small dimensions (10 to 20μ), making the construction water- and windproof while keeping it water vapor permeable. Laser perforation furthermore creates perforations with a very clean edge, without impacting the resistance to fissuring of the sheeting.

The thermal reflective foil preferably meets the requirements of building materials' category B2 following DIN 4102/1:1998/05 (Behavior in Fire of Building Materials and Building Parts, DIN standard of May 98). In order to meet this standard, the base sheeting contains a flame retardant, by preference on a basis of a brominated product and Sb₂O₃, preferably in a quantity of at least 5-10 percent in weight, in particular at least 8 percent in weight referred to the total weight of the base sheeting. The quantity of flame retardant, which has a density ranging between 1.0 and 1.5 g/cm³, in the present preferred design of the invention is measured in such a way that the mean value for “auto-extinguishing” of the flame lies at 10 seconds after pointing a burner for 15 seconds (DIN-default) on the side coated with the flame retardant. The texture and structure of the sheeting make migration of the flame retardant impossible.

The base sheeting comes in a preferred thickness of 140 μm to 220 μm, specifically 180 μm.

In a preferred design, the base sheeting furthermore comes in three layers, whereby the three layers are coextruded, which further improves the mechanical behavior, e.g., results in an even better resistance against puncturing and nail fissures, in particular when exposed to heath.

In this case, the center layer of the base sheeting contains high-density polyethylene (HDPE) (density 0.930-0.960 g/cm³) alone or combined with flame retardant, for example 85 to 95 percent in weight, referred to the total weight of the layer, of flame retardant. This center layer comes in a preferred thickness of 90 μm to 130 μm.

Both exterior layers of the base sheeting are preferably composed of a mixture of low-density polyethylene (LDPE) (density 0.924-0.930 g/cm³) and linear low-density polyethylene (LLDPE) (density 0.918-0.926 g/cm³; possible as a copolymeride with one or more comonomeres with extended chain olefines, e.g., butylene or otene) or metallocene-polyethlyene, or also combined with a flame retardant, for example 50-70 percent in weight, in particular 65 percent in weight LDPE, 25 to 40 percent in weight, in particular 30 percent in weight, LLDPE or metallocene-polyethylene and 5 to 10 percent in weight, in particular 5 percent in weight, of flame retardant, whereby all ratios of the percentages in weight refer to the total weight of an exterior layer. Both exterior layers preferably come in a thickness of 25 μm to 45 μm.

The metallization coat can be made of any metal or metal alloy resistant under the manufacturing conditions of the metallization coat, e.g., copper, zinc, brass, aluminum, silver and gold. A silver coat, preferably with a minimum thickness of 60 nm, is preferred because there is a higher demand for it and it is easier to recycle.

A non-combustible water-, solvent- and weathering-resistant coat is recommended for the protective coat on top of the metallization coat, e.g. a two-component polyurethane-based coat hardened with isocyanate. A preferred coat is composed of polyurethane components and isocyanate components, which are both available as organic solvents, mixed in a ratio of 2 parts by weight of polyurethane: 1 part by weight of isocyanate, generally applied in such a way that the pickup weight after drying, heating and hardening lies between 1.4 and 5.0 g/m². The coat has a highly scratch-resistant surface and a high gloss, is water-, solvent- and weathering-resistant and meets the requirements of the above-mentioned B2 standard.

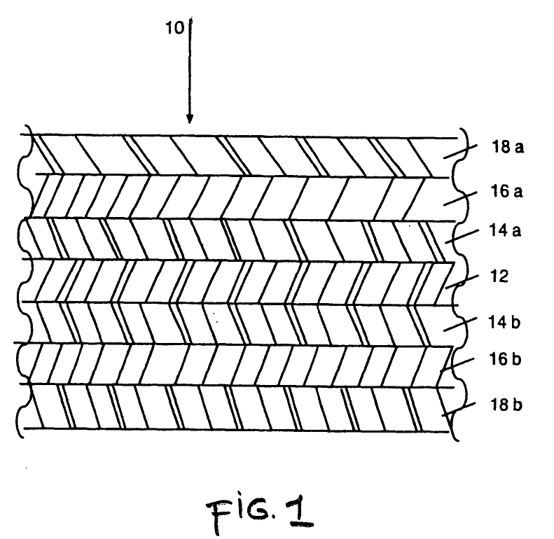

Below, the thermal reflective sheeting is explained in further detail by means of a clarifying, non-limiting example in reference to FIG. 1.

FIG. 1 shows a cross-section of a thermal reflective sheet 10. Layers 12, 14a and 14b build the base sheeting. In this example, layer 12 consists of 90 percent in weight of HDPE (GM 9240 from Basell Polyolefine Gmbh, Am Yachthafen 2, D-77694 Kehl, Germany) and 10 percent in weight of flame retardant (Clariantg PEA0025586 FH from Clariant Masterbatch GmbH & Co. OHG, Hohenrhein 1, D-56112 Lahnstein, Germany or alternatively FR Mastertrek® PE 373115 from the Campine Company, distributed by Helm AG, Nordkanalstrasse 28, D-20097 Hamburg, Germany), whereby the percentages in weight refer to the total weight of layer 12.

Layers 14a and 14b consist of a mixture of 55 percent in weight of LDPE (3020 D or 3010 D from the Basell Company) and 30 percent in weight of metallocene-polyethylene (Elite 5400 from Dow Europe S. A., Bachtobelstrasse 3, CH-8810 Horgen, Switzerland) and 5 percent in weight of the above-mentioned flame retardant, whereby the percentages in weight refer to the total weight of layer 14a and 14b, respectively. Layer 12 has a thickness between 90 μm and 130 μm, and layers 14a and 14b each have a thickness between 25 μm and 45 μm, whereby the base sheeting has a total thickness of 180 μm.

Layers 16a and 16b are composed of a vacuum-coated film of high-purity silver (with a purity of 99.99%) and have a thickness of 60 nm in the present design.

Layers 18a and 18b are polyurethane coats hardened with isocyanate (PUR-high-gloss coat VH 10117 from Zweihom GmbH, Düsseldorfer Strasse 96-100, D-40721 Hilden, Germany) serving as protective coats applied in intaglio printing or alternatively in flexographic printing. Depending on the application method, the quantity applied after drying is 1.4 and 5.0 g/m², respectively.

The thermal reflective sheeting described in this example meets the requirements of building materials' category B2.

As for the electromagnetic shielding of this design, electromagnetic fields are attenuated 300-fold (by 40 dB) from 30 MHz to 10 GHz.

A manufacturing method for the thermal reflective sheeting according to the invention goes as follows: First, a base sheeting is created with a blown film or flat foil extrusion cycle. In case of a three-layer base sheeting, the extrusion method used is co-extrusion. In order to improve the bond on the base sheeting, the extrusion exposes both sides of the sheeting to a corona discharge. Next, the treated sheeting is vaporized with a metal (preferably silver) and both sides of the sheeting vaporized with metal are covered with a protective coat, if necessary. In case of a diffusion-permitting sheeting, a perforation step is added.

The sheeting cannot only be used in roof construction, but also for example as heat insulation for rooms and as an adhesive tape for interior and exterior construction, whereby only one side of the sheeting is coated with a conductive adhesive.

The following is a clarifying, non-limiting example of a manufacturing method of preferred thermal reflective sheeting following the invention.

A three-layer base sheeting is coextruded using the blown film method. This base sheeting consists of a center layer of 90 percent in weight of HDPE and 10 percent in weight of flame retardant. Both exterior layers consist of a mixture of 65 percent in weight of LDPE and 30 percent in weight of LLDPE or metallocene-polyethlyene, and 5 percent in weight of flame retardant.

The temperature of the extruders for both exterior layers of the base sheeting lies between 190 and 200° C. The temperature in the center extruder, which has an HDPE as its main component, lies between 220 and 240° C.

The extrusion output of the sheeting lies between 300 to 360 kg/h for a total thickness of 180 μm. The withdrawal speed lies between 11.0-12.5 m/min for a 180 μm sheeting.

Next, both sides of the extruded sheeting undergo a corona discharge in order to improve bonding of the sheeting during further treatment. It is necessary to make sure that the base sheeting does not block up on the master roll because this would make further treatment of the base sheeting impossible.

The rolls of sheeting are wrapped in an installation, which can be evacuated, and subsequently vapor-deposited with silver. This is a semi-continuous process. Both sides of the base sheeting are metallized. Depending on the installation used, this can be done in one or two working cycles. The vaporization of the silver is done in a system of boats made of semi-conductive material. The boats are heated directly with power. The silver is added directly from a roll of wired silver, melted in the boats and then transferred as a vapor onto the sheeting. This requires a high-vacuum of about 104 mbar.

The quantity of silver deposited on the base sheeting is determined by the temperature and the passage speed, both set in such a way that the coating intensity of the silver is at 60 nm on each side.

Next, a protective coat is applied in order to protect the metallization of the base sheeting. This example uses the two-component polyurethane/isocyanate coat mentioned above. These components, which are both available as organic solvents, are mixed in a ratio of 2 parts by weight of polyurethane:1 part by weight of isocyanate right before the application. The mixture is applied in two working cycles (one for each side of the sheeting) in an intaglio installation or a flexographic installation. The intaglio printing or flexographic printing cycle is done in such a way that the pick-up weight after the drying and heating cycle lies between 1.4 and 5.0 g/m². This drying and heating cycle is necessary to harden the coat and obtain the best possible cross-linkage of the metallization. The heating cycle could be carried out with hot air or infrared radiation, for example.

Diffusion-permitting thermal reflective sheeting subsequently undergoes additional treatment in a laser perforation unit. A UV-laser (Power-Gator UV-laser (green), 15 W, from Lambda Physiks, Göttingen, Germany) burns perforations with a diameter of 10 μm to 20 μm in the sheeting. A highly diffusion-permitting sheeting has about 62,000 perforations/m2. The perforation is done in such a way that it covers the entire sheeting, except for a margin of 10 to 20 mm.

1. Thermal reflective sheeting for the building industry with a polyethylene-containing base sheeting and a vacuum metallized metallization coat on both sides, characterized by a protective coat on top of both metallization coats.

2. Thermal reflective sheeting following claim 1, characterized by the fact that the thermal reflective sheeting is diffusion-resistant.

3. Thermal reflective sheeting following claim 1, characterized by the fact that the thermal reflective sheeting is diffusion-permitting.

4. Thermal reflective sheeting following claim 3, characterized by the fact that the diffusion-permitting appearance is created by microperforation.

5. Thermal reflective sheeting following claim 4, characterized by microperforations with a diameter between 10 μm and 20 μm.

6. Thermal reflective sheeting following one of claims 1 through 5, characterized by the fact that the base sheeting contains a flame retardant.

7. Thermal reflective sheeting following claim 6, characterized by a thickness of the base sheeting of 140 μm to 220 μm.

8. Thermal reflective sheeting following one of claims 1 through 7, characterized by a base sheeting composed of three layers.

9. Thermal reflective sheeting following claim 8, characterized by a base sheeting with a center layer of high-density polyethylene (HDPE).

10. Thermal reflective sheeting following claim 9, characterized by a base sheeting with a center layer composed of 85-95 percent in weight of HDPE, referred to the total weight of the layer, and 5-15 percent in weight of flame retardant, referred to the total weight of the layer.

11. Thermal reflective sheeting following claim 9 or 10, characterized by a base sheeting with a center layer with a thickness of 90 to 130 μm.

12. Thermal reflective sheeting following one of claims 8 through 11, characterized by the fact that both exterior layers of the base contain low-density polyethylene (LDPE) and linear low-density polyethylene (LLDPE) or metallocene-polyethylene.

13. Thermal reflective sheeting following claim 12, characterized by the fact that both exterior layers of the base sheeting contain 50-70 percent in weight of LDPE, 25-40 percent in weight of LLDPE or metallocene-polyethylene, and 5-10 percent in weight of flame retardant. All percentages in weight refer to the total weight of the layer.

14. Thermal reflective sheeting following claim 12 or 13, characterized by the fact that both exterior layers have a thickness of 25 μm to 45 μm.

15. Thermal reflective sheeting following one of claims 1 through 14, characterized by a metallization coat made of silver.

16. Thermal reflective sheeting following one of claims 1 through 15, characterized by a metallization coat with a minimum thickness of 60 nm.

17. Thermal reflective sheeting following one of claims 1 through 16, characterized by a two-component protective coat on a polyurethane basis hardened with isocyanate.

18. Thermal reflective sheeting following claim 17, characterized by the fact that the dispersion coat is applied in a dry quantity of 1.4 to 5.0 g/m².

19. Thermal reflective sheeting following one of claims 6 through 18, characterized by the fact that it meets the requirements of building materials' category B2 following DIN 4102/1:1998/05.

20. Thermal reflective sheeting following one of claims 1 through 19, characterized by the fact that it is wind- and waterproof (resistant to rain and downpours), emission-free, highly fissure-resistant, highly UV-resistant, light-proof, heat reflecting, and has a temperature resistance ranging from −45° C. to +95° C. as well as excellent electromagnetic shielding performance over a wide range of temperatures and frequencies.

21. Manufacturing method for thermal reflective sheeting following claim 1, with the following steps:
a) Extrusion of a polyethylene-containing base sheeting by means of a blown film or flat foil extrusion cycle;
b) Treatment of both sides of the sheeting obtained under a) with a corona discharge.
c) Two-sided vapor-depositing of the sheeting obtained under b) with a metal, preferably silver, as well as
d) Application of a protective coat on both sides of the sheeting obtained under c).

22. Manufacturing method following claim 21, characterized by the coextrusion of a three-layer base sheeting described in step a), whereby the center layer contains HDPE and both exterior layers contain LDPE or LLDPE.

23. Manufacturing method following claim 21 or 22 for a diffusion-permitting sheeting following claim 3, characterized by an additional step e) in which the sheeting obtained in steps c) or d) from claim 21 or 22 are perforated.

24. Use of the thermal reflective sheeting as prestressed subroofing following one of claims 1 through 20.

25. Interior or exterior use of the thermal reflective sheeting following one of claims 1 through 20 as an adhesive tape, whereby one side of the sheeting is coated with a conductive adhesive.
